(19) United States
(12) Patent Application Publication
(10) Pub. No.: US 2009/0176522 A1
(43) Pub. Date: Jul. 9, 2009

(54) Method for carrying out a survey of a plurality of participant communication devices, and corresponding communication drives

(75) Inventors: Frank Kowalewski, Salzgitter (DE); Achim Luft, Braunschweig (DE)

Correspondence Address: LERNER GREENBERG STEMER LLP, P O BOX 2480, HOLLYWOOD, FL, 33022-2480, US

(73) Assignee: Siemens Aktiengesellschaft

(21) Appl. No.: 10/585,158

(22) PCT Filed: Oct. 22, 2004
(86) PCT No.: PCT/EP04/52632

§ 371 Date: Jun. 29, 2006

(30) Foreign Application Priority Data
Jan. 2, 2004 (DE) 10 2004 001 013.7

(51) Int. Cl. H04B 7/00; H04B 1/38

(52) U.S. Cl. 455/517; 455/90.2

(57) ABSTRACT

A method for carrying out a survey of a plurality of participant communication devices, and corresponding communication devices. In order to carry out a survey of a plurality of participant communication devices, each of these communication devices is successively assigned an exclusive transmission right to transmit at least one useful message during an authorization period, on the basis of a specific request signal, while the other participant communication devices are only assigned a reception right to receive at least one useful message. The communication device authorized to transmit determines a time window for each participant communication device to respond to the survey, within which the respective participant communication device can transmit its response signal in that it sends at least once its own specific request signal as response signal in order to request the exclusive transmission right.

Conventional radiophones, which are known for example by the name Walkie-Talkie, allow speech messages to be sent in real time to one or more partners. During speech the transmitting party presses a specific speaking key. As a result he blocks other participants from speaking. Transmission takes place therefore according to a semi-duplex system. Communications services of the semi-duplex system type are also called PTT services (PTT: Push To Talk). The current Push-to-Talk services generally only allow transmission of speech messages.

The object of the invention is to carry out a survey of a plurality of participant communications devices in a simple manner. This object is achieved by the following method according to the invention:

Method for carrying out a survey of a plurality of participant communications devices, wherein only one of these communications devices in each case is assigned an exclusive transmission right to transmit at least one useful message during an authorization period, on the basis of its specific request signal, while the other participant communications devices are only assigned a reception right to receive at least one useful message, and wherein the communications device authorized to transmit determines a time response window for the survey of the participant communications devices, within which window it is possible for the respective participant communications device to provide its respective response signal to the survey in that it sends at least once its own specific request signal as the response signal for requesting the exclusive transmission right.

As a result of the fact that the respective participant communications device provides its respective response signal to the survey, that it sends at least once its own specific request signal as the response signal, it is possible to use the existing functionalities of the participant communications devices without modification to carry out a survey. Thus communications devices that are already in use can be used to carry out a survey without any special modification.

As a result of the method according to the invention, different types of survey may advantageously be carried out. These include surveys with Yes/No responses, with one response from a plurality of possible responses, with multiple responses from a plurality of possible responses, or with responses which require a text to be input. The text is input into the communications device in the form of a Morse code for example.

Simple handling of the conducting of a survey, both for the communications device authorized to transmit and which initiates the survey, and for the other participant communications devices which participate in the survey, is also achieved.

The invention also relates to a communications device authorized to transmit for carrying out a survey of a plurality of participant communications devices, comprising a reception unit for receiving its exclusive transmission right to transmit at least one useful message during an authorization period, on the basis of its specific request signal, while the other participant communications devices can only be assigned a right to receive at least one useful message, comprising a processing unit for determining a time window within which it is possible for every communications device participating in the survey to provide its respective response signal to the survey in that it sends at least once its own specific request signal as the response signal for requesting the exclusive transmission right, and comprising a transmission unit by means of which its response signal can be sent by sending at least once its own specific request signal to request an exclusive transmission right.

The invention also relates to a communications device authorized to receive for carrying out a survey of a plurality of participant communications devices, comprising a transmission unit by means of which its response signal can be sent by sending at least once its own specific request signal to request an exclusive transmission right.

Other developments of the invention are recited in the sub-claims.

The invention and its developments will be described in more detail hereinafter with reference to drawings, in which:

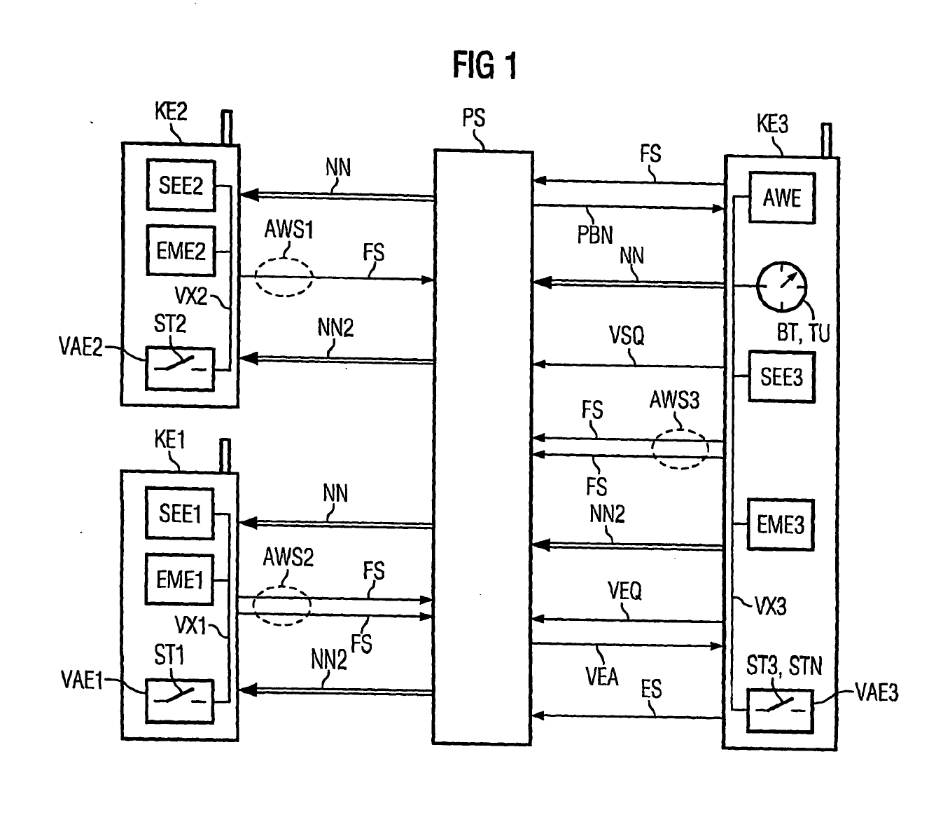

FIG. 1 shows, in a schematic diagram, an arrangement for carrying out a survey of a plurality of participant communications devices according to a first variant of the method according to the invention and associated modifications, and

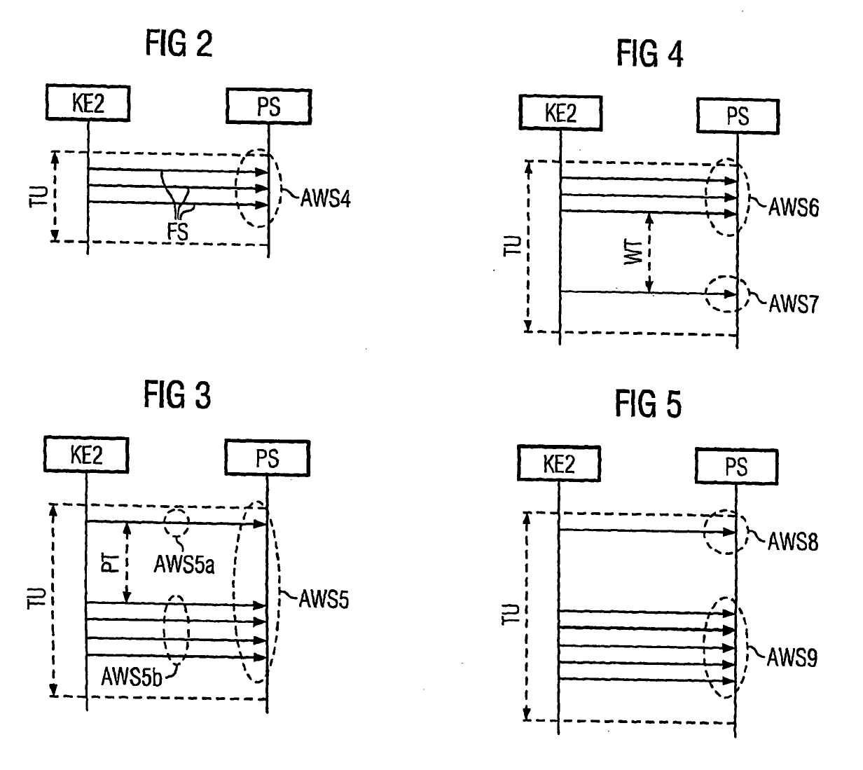

FIG. 2 to 5 show different variations of response signals which may be provided by the respectively responding communications device when carrying out different variations of the survey method according to the invention.

Elements with the same function and mode of operation are provided with the same reference numerals in FIG. 1 to 5.

FIG. 1 shows an embodiment for a PTT system (Push-to-Talk). A service of a PTT system is called a PTT service. A possible specification for a PTT system is given for example in the document “Push-to-Talk over Cellular (PoC), Architecture v.1.1.0, PoC Release 1.0, at “http://www.ericsson.com/multiservicenetworks/distr/PoC_specifications.ZIP”.

This Push-to-Talk system has a star-type organization. A central PTT server PS, which is connected to all participant communications devices KE1, KE2, KE3, is located in the center of FIG. 1. The PTT server PS controls the PTT service and distributes the relevant communications signals to the participant communications devices KE1, KE2, KE3.

Within the scope of the invention the term “communications device” includes a mobile communications device according to the UMTS standard (UMTS—Universal Mobile Telecommunications System) or according to the GSM standard (GSM—Global System for Mobile). According to a further embodiment a communications device can be produced as a landline device, for example as an ISDN terminal (ISDN—Integrated Subscriber Digital Network) or as a computer unit connected to the public internet and/or intranet.

A PTT service is conventionally characterized in that only one of the communications devices in each case, such as KE3, is assigned an exclusive transmission right to transmit at least one useful message, such as NN, NN2, during an authorization period, such as BT. During this authorization period BT the other communications devices, such as KE1 and KE2, participating in the survey are only assigned a reception right to receive at least one useful message NN, NN2. Useful messages NN, NN2 are transmitted in this case according to a semi-duplex system. The useful message NN, NN2 is delivered in real time to the communications devices KE1, KE2 authorized to receive. The useful message NN, NN2 can inter alia comprise multi-media data, such as audio data, video data or text data.

In FIG. 1 the communications device KE3 has the exclusive transmission right to transmit useful messages NN, NN2. It comprises a transmission unit SEE3 for sending one or more signal(s) and/or message(s) and a reception unit EME3 for receiving one or more signal(s) and/or message(s). In addition there is an evaluation unit AWE for evaluating the survey and a management unit VAE3 which controls the survey for example. Finally, there is also an interconnecting network VX3 which allows the exchange of information between the various units SEE3, EME3, AWE and VAE3 of this communications device KE3.

The communications devices KE1, KE2 in FIG. 1 are also only authorized to receive at least one useful message NN, NN2. They have a respective transmission unit SEE1, SEE2 for sending one or more signal(s), and/or message(s) and a respective reception unit EME1, EME2 for receiving one or more signal(s) and/or message(s). They also include a respective management unit VAE1, VAE2 to generate the respective response signal AWS1, AWS2 for example. In addition a respective interconnecting network VX1, VX2 is provided which allows the exchange of information between the various units SEE1, EME1 and VAE1 and SEE2, EME2 and VAE2 within the respective communications device KE1, KE2.

The course over time for carrying out a survey will be described in more detail hereinafter with reference to FIG. 1. This survey is initiated by communications device KE3. Once the communications devices KE1, KE2, KE3 participating in the survey have registered with the PTT server, the communications device KE3 sends its specific request signal FS to the PTT server PS. It thereby requests the exclusive transmission right to transmit useful messages NN, NN2. The PTT server PS then decides whether the exclusive transmission right can be assigned to the communications device KE3 making the request. As no other communications device KE1, KE23, KE3 has been assigned the exclusive transmission right, the PTT server PS assigns the exclusive transmission right to the communications device KE3 making the request by means of a positive acknowledgement message PBN. The communications device KE3 authorized to transmit accordingly has the possibility, within the authorization period BT, to send at least one useful message NN, NN2 or to also initiate at least one survey.

At the start of the survey the communications device KE3 authorized to transmit transmits at least one useful message to the PTT server which forwards this in real time to the communications devices authorized to receive. This useful message contains a question and possibly also a choice of possible responses to the survey. This useful message can optionally be configured in the form of a speech message or a text message. In this embodiment the communications device KE3 sends the useful message NN with the following question to the PTT server PS: “Shall we go for dinner? Please answer with Yes or No”. As soon as it has received this useful message NN the PTT server PS forwards it to the communications devices KE1, KE2.

A time window is then started by the communications device authorized to transmit, within which it is possible for the communications devices KE1, KE2, KE3 participating in the survey to provide their respective response signal AWS1, AWS2, AWS3 to the survey. It may be advantageous to communicate the start of the time response window, for example by means of an audio signal, to the communications devices participating in the survey. Thus a first audio signal can be generated for example by pressing a survey key STN on the communications device KE3 authorized to transmit. This signal is incorporated into the useful message NN and transmitted to the other communications devices KE1, KE2 participating in the survey. In an alternative variation, a text message is transmitted to the communications device participating in the survey, which message indicates the start of the time response window TU. In this embodiment the communications device KE3 authorized to transmit adds the following additional text to the useful message NN with the question: “Please give your answer now”.

At the same time, or in advance, the communications device KE3 authorized to transmit informs the PTT server PS about the start of the time response window TU by means of a survey status message VSQ. The PTT server PS can optionally not allow any new communications devices for this PTT service during the time response window TU. In addition the server can buffer the specific request signals FS sent within the time response window TU by the communications devices KE1, KE2, KE3 participating in the survey for subsequent evaluation of the survey.

Once the time response window has started, the communications devices participating in the survey have the opportunity to provide their respective response signal to the survey. It is advantageous that the specific request signal, such as FS, is sent at least once. In the present embodiment the “Yes” response is provided by sending the specific response signal FS once and the “No” response by sending the specific response signal FS twice. The communications device KE2 answers “yes” in response to the survey. The communications devices KE1, KE3 answer “No”. The communications device KE2 thus sends its specific request signal FS to the PTT server PS once for its response signal AWS2. The other two communications devices KE1 and KE3 transmit their respective specific request signal FS twice in each case. Their response signals AWS1, AWS2 are thus comprised of two respective specific request signals FS which are surrounded in FIG. 1 by a broken ring.

After reaching the end of the time response window, no further response signals from the communications devices participating in the survey are taken into account. The end of the time response window can for example be announced by a second audio signal. This is sent by the communications device authorized to transmit, such as KE3, by means of a further useful message, such as NN2, to the PTT server and subsequently to the other communications devices participating in the survey, such as KE1 and KE2. In addition it is possible for the end of the time response window to be determined at the start of the time response window and to automatically elapse after the predetermined time. Alternatively it may optionally also be expedient to indicate the end of the time response window to the participant communications devices by means of a text or picture message. In the embodiment of FIG. 1 the communications device KE3 authorized to transmit sends the useful message NN2 to the PTT server PS, which message indicates the end of the time response window TU. This useful message NN2 includes the speech message “The survey has now finished”. As soon as the PTT server PS has received this useful message NN2 it forwards it to the communications devices KE1, KE2.

Once the time response window has ended, the communications device authorized to transmit retrieves from the PTT server status information which relates to the survey. The communications device authorized to transmit inquires by means of a result inquiry message how many communications devices participated in the inquiry and how many decided on the respectively admissible responses. The PTT server then responds with at least one result response message and hereby transmits the status information inquired about to the communications device authorized to transmit. In the embodiment of FIG. 1 the communications device KE3 requests, with the result message VEQ, some status information with respect to the survey from the PTT server PS. The PTT server PS transmits the following status information to the communications device KE3 by means of the result response message VEA:
number of communications devices which participated in the survey: 3
number of communications devices which provided their specific request signal once in each case during the time response window: 1
number of communications devices which provided their specific request signal twice in each case during the time response window: 2

This status information is evaluated in the communications device authorized to transmit by means of an evaluation unit. One or more survey result(s) is/are compiled therefrom. Alternatively the evaluation can also be made manually by the user of the communications device authorized to transmit. In the embodiment the evaluation device AWE of the communication device KE3 evaluates the status information. The survey result indicates that one of the three participant communications devices KE1, KE2, KE3 voted “Yes” and two of the three participant communications devices KE1, KE2, KE3 voted “No”.

In a further step one or more survey result(s) can be forwarded for example to the communications devices participating in the survey. It can be expedient to transmit one or more survey result(s) in text form, for example via SMS (SMS—Short Message Service). In the present embodiment of FIG. 1 the following useful message NN2 is forwarded as the survey result by the communications device KE2 to the communications devices KE1, KE3: “The result of the survey is: NO”.

Finally, the communications device authorized to transmit again provides its transmission right to transmit useful messages. For this purpose the communications device KE3 authorized to transmit sends a transmission end message ES to the PTT server PS, whereupon the PTT server PS cancels the exclusive transmission right.

Generation of the specific request signal may be triggered by actuating a key on the communications device. The specific request signal may be sent by means of a transmission unit. It is advantageous in practice to use this key to also provide the response signal. In FIG. 1 the respective request signal FS is triggered by pressing the respective key ST1, ST2, ST3 on the respective communications device KE1, KE2, KE3. The respective key ST1, ST2, ST3 is housed inside the respective management unit VAE1, VAE2, VAE3. The respectively generated specific request signal FS is then sent by means of the respective transmission unit SEE1, SEE2, SEE3. In FIG. 1 the respective response signal AWS1, AWS2, AWS3 is effected by pressing the respective key ST1, ST2, ST3 of the communications device KE1, KE2, KE3.

It is also possible with the method according to the invention to carry out different types of surveys by sending the specific request signal FS once or several times:

Survey with Yes/No Responses:

With this type of survey a Yes or No response is anticipated. A Yes response can be indicated by sending the specific request signal FS once. A No response can be communicated in that no specific request signal FS is sent during the time response window TU. In general the Yes/No response signals can be generated in that both differ by different combinations of sending and/or not sending one or more request signal(s).

Survey with a Response from a Plurality of Possible Responses:

In this case the communications device participating in the survey can provide one of the possible responses. The response signal pertaining to a response consists of a combination of sending and/or not sending one or more request signal(s). A clear combination is selected for each response signal. For example there are four responses to choose from. In this case the first response is expressed by sending the specific request signal FS once, the second response by sending it twice, the third response by sending it three times and the fourth response by sending it four times during the time response window TU. According to FIG. 2, the responding communications device KE3 decides on the third response and therefore sends its specific request signal FS three times during the time response window TU for its response signal AWS4.

Survey with more than once Response from a Plurality of Possible Responses:

In this case the participant communications device can provide more than one response from a plurality of possible responses during the time response window. The partial response signal associated with a specific response consists of a combination of sending and/or not sending one or more request signal(s). To provide a plurality of responses within the response signal, these partial response signals are sequentially arranged one after the other. To distinguish between the individual responses it may be expedient to take into account a waiting time PT between provision of the individual responses. In the example of FIG. 3, there are four responses to choose from, wherein the responses one and four are provided. For this purpose communications device KE2 sends the first partial response signal AWS5A, which consists of a single specific request signal FS. After a waiting pause PT, for example of two seconds, the communications device KE2 signals its second partial response signal AWS5B, i.e. response four, by sending its specific response signal FS four times. The response signal AWS5 for this survey is thus composed of the first partial response signal AWS5A, followed by a waiting time PT and subsequently of the second partial response signal AWS5B. This response signal AWS5 is provided during the time response window TU.

Survey with Rows of Text or Letters as the Response:

In this case one or more letter(s) and/or number(s) are provided as the response. For example a question is asked about a specific year or the name of a prominent actor. For this purpose the participant communications device can provide its respective response signal in that a clear combination of sending and/or not sending of the specific request signal FS is clearly allocated to each letter and/or each number. Using sequential transmission of a plurality of letters and/or numbers corresponding rows of letters and/or numbers may also be formed. This clear allocation can for example be produced in the form of a Morse code. Alternatively or additionally the letters and/or numbers can be input with the aid of a keypad, wherein a letter and/or a number is potentially allocated to a specific key on the keypad. By actuating a key a letter and/or number is reproduced in the form of a clear combination of sending and/or not sending of the specific request signal. As an example, a question is asked in a survey about a date which consists of four numbers, for example 1992. If the respective communications device is in the form of a mobile phone according to the GSM standard and comprises a 3×4 keypad, this keypad thus reproduces inter alia the numbers 0 to 9 with a separate key in each case. When a key is actuated a clear combination of sending and/or not sending of the specific request signal FS is generated and transmitted. By pressing the keys “1”, “9”, “9” and “2” the corresponding response signal to the survey is provided.

In practice it may be expedient to correct one or more response signal(s) during the time response window. According to FIG. 4 a provided response signal AWS may be corrected in that a further response signal corrects the provided response signal after a waiting time WT following provision of a response signal. In the present example the response signal AWS6 is firstly provided by sending the specific request signal FS three times. After the waiting time WT, such as three seconds, this is overwritten by the further response signal AWS7 which consists of sending the specific request signal FS once. The response signals AWS6, AWS7 were provided during the time response window TU.

According to a further alternative development, it may be expedient to cancel one or more provided response signal(s) during the time response window TU. According to FIG. 5, a clear combination of sending and/or not sending of the specific request signal is used as the clearing signal. For example in a survey in which a response signal AWS8 has already been provided by sending the specific request signal FS once, cancellation is possible by providing the clearing signal AWS9. The clearing signal AWS9 is produced by four specific request signals FS sent in quick succession.

As an alternative to evaluation of the response signal by way of the communications device authorized to transmit, evaluation may also take place by way of the PTT server. For this purpose the communications device authorized to transmit transmits a result request signal to the PTT server once the time response window has ended. The PTT server thereupon evaluates one or more item(s) of status information which relate(s) to the survey and establishes one or more survey result(s). It then sends one or more survey result(s) by means of at least one result response signal to the communications device authorized to transmit. Alternatively the PTT server can distribute the survey result directly to the communications devices participating in the survey. According to FIG. 1 the communications device KE3 requests the survey result from the PTT server PS by means of the result request signal VSQ. The PTT server PS then sends the survey result to the communications device KE3 by means of the result response signal VEA.

In a further embodiment the communications device authorized to transmit can ask the PTT server, PS for example in this case, to transmit current status information during the survey. This can take place by means of the survey status message, VSQ for example in this case. During the survey actually occurring status information on the survey is accordingly communicated to the communications device authorized to transmit. The communications device, which has just provided its response signal or/and its specific request signal FS, provides this status information.

In a possible additional embodiment it is possible during the survey to restrict or extend specific control and/or request functions in the communications devices participating in the survey. For example it may be advantageous for communications devices authorized to receive, for example KE1, KE2, to not be able to request status information from the PTT server, for example PS, about the progression of the survey. This may include the request as to how often a specific communications device has sent its specific request signal, such as FS, during the time response window, for example TU.

Furthermore it may be expedient for specific functions within the PTT server to be blocked or activated. Thus it may be advantageous in practice that no additional communications devices are incorporated into the survey by the PTT server during the time response window, for example TU.

1-10. (canceled)

11. A method for carrying out a survey of a plurality of participant communications devices, which comprises:
assigning only a respective one of the communications devices an exclusive transmission right to transmit at least one useful message during a given authorization period, on a basis of a specific request signal of the one communication device, and assigning the other participant communications devices only a reception right to receive at least one useful message during the given authorization period;
determining, with the one communications device authorized to transmit, a time response window for the survey of the participant communications devices, within which time response window the respective participant communications device is enabled to provide a respective response signal to the survey by transmitting the specific request signal at least once as the response signal for requesting the exclusive transmission right.

12. The method according to claim 11, wherein the respective communications device is a device selected from the group consisting of a mobile communications device according to the UMTS standard or the GSM standard, a landline device according to the ISDN standard, and a computer unit connected to the Internet and/or an intranet.

13. The method according to claim 11, which comprises triggering the request signal for requesting the exclusive transmission right to transmit the useful message by actuation of a key on the communications device.

14. The method according to claim 11, which comprises generating the response signal by actuating a respective key on the respective communications device during the time response window.

15. The method according to claim 11, which comprises evaluating the respective response signal with an evaluation unit during the time response window.

16. The method according to claim 15, wherein the evaluation unit is integrated in the communications device having authorization to transmit.

17. The method according to claim 11, which comprises overwriting the response signal, provided by a communications device, with a following further response signal within the time response window.

18. The method according to claim 11, which comprises selectively limiting or expanding a control and/or request function of the communications devices participating in the survey during the survey.

19. A method for carrying out a survey of a plurality of participant communications devices, which comprises:
receiving a specific request signal for an exclusive transmission right from one communications device of the plurality of participant communications devices;
assigning the one communications device an exclusive transmission right to transmit a useful message during a given authorization period;
assigning the remaining participant communications devices only a reception right to receive a useful message during the given authorization period;
defining, with the one communications device, a time response window for receiving response signals from the participant communications devices; and
enabling a respective participant communications device to provide a response signal to the survey by transmitting the specific request signal at least once as the response signal for requesting the exclusive transmission right.

20. A communications device with authorization to transmit for carrying out a survey of a plurality of participant communications devices, comprising:
a reception unit for receiving an exclusive transmission right to transmit at least one useful message during an authorization period, on the basis of a specific request signal thereof, while other participant communications devices can only be assigned a reception right to receive at least one useful message;
a processing unit connected to said reception unit for determining a time window during which each communications device participating in the survey is enabled to provide a respective response signal to the survey by transmitting, at least once, a specific request signal associated with the communications device for requesting the exclusive transmission right as the response signal; and
a transmission unit configured to transmit the response signal by sending, at least once, the specific request signal requesting an exclusive transmission right.

21. A communications device authorized to receive for carrying out a survey of a plurality of participant communications devices, comprising a transmission unit for sending a response signal by sending, at least once, a specific request signal associated with the communications device to request an exclusive transmission right.

22. The communications device according to claim 21 configured as one of the participant communications devices of claim 11.
